(19) United States
(12) Patent Application Publication
(10) Pub. No.: US 2008/0226355 A1
(43) Pub. Date: Sep. 18, 2008

(54) DEVELOPMENT DEVICE, PROCESS CARTRIDGE, AND IMAGE FORMATION APPARATUS

(76) Inventors: Kyohta KOETSUKA, Fujisawa-shi (JP); Tadaaki Hattori, Hadano-shi (JP); Yoshiyuki Takano, Hachioji-shi (JP); Noriyuki Kamiya, Yamato-shi (JP); Masayuki Ohsawa, Atsugi-shi (JP); Mieko Terashima, Isehara-shi (JP); Hiroya Abe, Yokohama-shi (JP); Takashi Innami, Atsugi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/045,936

(22) Filed: Mar. 11, 2008

(30) Foreign Application Priority Data
Mar. 15, 2007 (JP) 2007-066478

(51) Int. Cl. G03G 15/09

(52) U.S. Cl. 399/277

(57) ABSTRACT

A development device includes a developer support body including a non-magnetic hollow body which contains a magnetic field generator and attracts a developer onto an outer surface by a magnetic force of the magnetic field generator, a magnetic member being disposed around the magnetic field generator and exerting a magnetic force on the magnetic field generator, and an anti-deflection magnetic field generator being provided around the hollow body and exerting a magnetic force on the magnetic field generator to prevent a deflection of the magnetic field generator by negating at least one of the magnetic force of the magnetic member and a gravitational force due to empty weight of the magnetic field generator.

### CROSS REFERENCE TO RELATED APPLICATION

The present application is based on and claims priority from Japanese Patent Application No. 2007-066478, filed on Mar. 15, 2007, the disclosure of which is hereby incorporated by reference herein in its entirety.

### BACKGROUND OF THE INVENTION

1. Field of the Invention

The present invention relates to a development device, a process cartridge, and an image formation apparatus for use in a copier, a facsimile machine, a printer, or the like. Particularly, it relates to a development device which includes an image support body to support magnetic particles and a magnetic particle support body and carries the magnetic particles to an develop area formed by the image support body and magnetic particle support body facing each other with a spacing, to develop an electrostatic latent image on the image support body to a toner image. It also relates to a process cartridge including the development device, and an image formation apparatus using the process cartridge.

2. Description of the Related Art

In recent years there has been a strong demand for downsizing the development device along with downsizing and full colorization of electronic photographic devices. In two-component magnetic brush development system using a developer made of a toner and a magnetic carrier, it is necessary to downsize a development roller as a main component thereof for the purpose of achieving the downsize of the development device. However, it is difficult to downsize the development roller with its magnetic force and rigidity maintained high because to increase the magnetic force, it is effective to increase volume of magnets but at the same time the increase in volume of magnets results in reducing the volume of a metal shaft for holding the development roller, causing a reduction in the rigidity of a magnetic roller. The reduction in the rigidity is more conspicuous in a shaftless integral magnetic roller.

The development roller attracts the developer by the magnetic force of the magnetic roller and carries it by rotation of a sleeve disposed around the magnetic roller, which receives gravitational force and magnetic attraction from the developer which is a magnetic material.

In a typical development device, a large amount of developer is attached on a developer container or a doctor portion; therefore, the magnetic roller receives magnetic attraction therefrom. Similarly, a doctor blade provided for carrying a predetermined amount of developer to a photoconductive drum generally includes a magnetic body or a magnetic portion which magnetically attracts the magnetic roller. A typical two-component magnetic brush type development device is not designed with the magnetic attraction from its own components taken into consideration. As a result, the magnetic attraction does not occur uniformly in a circumferential direction so that the magnetic roller receives a vectorial sum of the magnetic attractions from the respective components. This may cause various problems such that a deflection occurs on the magnetic roller when the rigidity of the magnetic roller is not sufficient, or that a variation in magnetic flux density makes the amount of developer nonuniform in a longitudinal direction and makes density of an image nonuniform accordingly. Furthermore, with a large deflection thereon, the magnetic roller may get in contact with the development sleeve, causing an increase in rotation torque, or even worse, destructing the magnetic roller.

In view of solving the above problems, disposing a rotatable member with high rigidity and good slidability in a magnetic roller body or a magshaft has been proposed. With such a configuration, the rotating member can be made in contact with the sleeve, thereby maintaining a gap therebetween. However, there are some drawbacks in the rotatable member that it makes the structure of the device more complex and increases the size and production cost thereof. Accordingly, it is not suitable for a small-size development roller. Another problem is that an increase in torque of the development sleeve is unavoidable when the development sleeve is made in contact with the magnetic roller.

Japanese Laid-open Patent Application Publication No. Sho 62-135862 discloses a development device having a magnetic member to negate a gravitational force on the magnetic roller and a magnetic force from a developer restriction blade thereon. However, the development device is not for the two-component magnetic brush development; therefore, it cannot achieve great effects even if applied therefor.

### SUMMARY OF THE INVENTION

An object of the present invention is to provide a durable development device which can form images in high quality with a little deflection of the magnetic roller without increasing the rigidity thereof and the rotation torque of the development sleeve, as well as to provide a process cartridge including such a development device and an image formation apparatus including such a process cartridge.

According to one aspect of the present invention, a development device is configured to comprise: a developer support body including a non-magnetic hollow body which contains a magnetic field generator and attracts a developer onto an outer surface by a magnetic force of the magnetic field generator; a magnetic member being disposed around the magnetic field generator and exerting a magnetic force on the magnetic field generator; and an anti-deflection magnetic field generator being provided around the hollow body and exerting a magnetic force on the magnetic field generator to prevent a deflection of the magnetic field generator by negating at least one of the magnetic force of the magnetic member and a gravitational force due to empty weight of the magnetic field generator.

According to another aspect of the present invention, the development device is provided with the anti-deflection magnetic field generator in a housing of the development device.

According to another aspect of the present invention, in the development device the magnetic member is the developer unevenly distributed around the magnetic field generator and a magnetic member of a restriction blade.

According to another aspect of the present invention, in the development device the anti-deflection magnetic field generator is made of a magnet.

According to another aspect of the present invention, the development device comprises two or more developer support bodies.

According to another aspect of the present invention, in the development device the developer is made of a toner and a magnetic carrier, and a mean particle size of the magnetic carrier is 20 μm or more and 35 μm or less.

According to another aspect of the present invention, in the development device a large number of recessions in an elliptic shape are formed randomly on the outer surface of the non-magnetic hollow body.

According to still another aspect of the present invention, a process cartridge is configured to comprise a development device which comprises a developer support body including a non-magnetic hollow body which contains a magnetic field generator and attracts a developer onto an outer surface by a magnetic force of the magnetic field generator; a magnetic member being disposed around the magnetic field generator and exerting a magnetic force on the magnetic field generator; and an anti-deflection magnetic field generator being provided around the hollow body and exerting a magnetic force on the magnetic field generator to prevent a deflection of the magnetic field generator by negating at least one of the magnetic force of the magnetic member and a gravitational force due to empty weight of the magnetic field generator.

According to still another aspect of the present invention, an image formation apparatus is configured to comprise the above-mentioned process cartridge.

### BRIEF DESCRIPTION OF THE DRAWINGS

FIG. 1 shows a development device according to a first embodiment of the present invention;

FIG. 2 shows a development device according to a second embodiment of the present invention;

FIG. 3A is cross sectional view showing a development device according to a third embodiment of the present invention, and FIG. 3B is an enlarged view of the periphery A of a magnet 221a′ of an anti-deflection magnetic field generator;

FIG. 4A shows a force acting on a magnetic roller of an upper development roller in a development device according to a fourth embodiment of the present invention;

FIG. 4B shows a force acting on a magnetic roller of a lower development roller;

FIG. 5 shows an example of the surface of a sleeve;

FIG. 6 shows an example of an image formation apparatus including a process cartridge having the development device according to the present invention; and

FIG. 7 shows an example of a process cartridge having the development device according to the present invention.

### DETAILED DESCRIPTION OF THE PREFERRED EMBODIMENTS

### First Embodiment

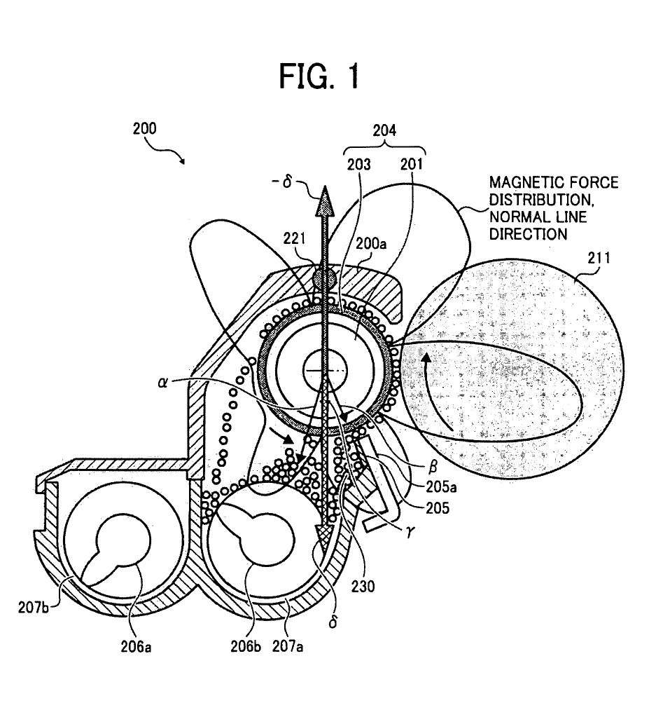

Hereinafter, the development device of the first embodiment will be described with reference to FIG. 1. FIG. 1 shows a development device 200 according to the first embodiment of the present invention. The development device 200 is configured to comprise a development roller 204 as a developer support body which includes a metal sleeve 203 (to rotate counterclockwise in the drawing) as a non-magnetic hollow body containing a fixed magnetic roller 201 as a magnetic field generator to absorb a developer 230 on its outer surface by a magnetic force of the magnetic roller 201.

The developer 230 is made of evenly distributed magnetic particles and toner particles and is attracted into the surface of the development roller 204 by the magnetic force of the development roller 204 and moved by the rotation of the sleeve 203 while circulated between developer tanks 207a, 207b by agitation of two agitation screws 206a, 206b. A magnetic plate 205a of a restriction blade 205 limits the amount of the developer 230 to a moderate amount to be supplied to a photoconductive drum 211. The rest of the developer 230 is moved to a left side of the development roller 204 (in the drawing) and separated therefrom due to absence of the magnetic force and empty weight thereof and returns to the developer tank 207a.

The sleeve 203 is surrounded by a housing 200a of the development device 200. On the housing 200a a magnetic metal member (made of SUM24L (nickel coated)) 221 is disposed as an anti-deflection magnetic field generator for preventing a deflection of the magnetic roller 201 caused by the magnetic force of the magnetic member disposed around the magnetic roller 201 and a gravitational force of empty weight of the magnetic roller 201. Here, changing both or one of the material and size of the magnetic metal member 221 makes it possible to adjust acting force between the magnetic metal member 221 and the magnetic roller 201.

The magnetic metal member 221 is the developer 230 unevenly distributed around the magnetic roller 201 and a magnetic metal plate 205a of a restriction blade 205 (doctor blade) in the present embodiment. However, it can include a member or a material causing a deflection of the magnetic roller 201 by a magnetic force.

As shown in FIG. 1, a force indicated by a vector α is exerted on a central axis of the magnetic roller 201 from the developer 230, as well as a force indicated by a vector β from the magnetic metal plate 205a, and a force indicated by a vector γ from the empty weight of the magnetic roller 201. The vector δ represents a combined force of these forces.

The magnetic metal member 221 of a long length is disposed on the housing 200a at a position inverse to the vector δ relative to the central axis of the magnetic roller 201, so that it exerts a force (a vector −δ) on the central axis of the magnetic roller 201 in the same magnitude but inversely to the force indicated by the vector δ. Thereby, it is possible to prevent a deflection of the magnetic roller 201 which otherwise occurs because of the magnetic force of the developer 230 and magnetic metal plate 205a and the empty weight of the magnetic roller 201. This accordingly makes it possible to make the amount of the developer 230 attached on the development roller 204 uniform in the longitudinal direction. An image formation apparatus incorporating this development device can form images with uniform density.

In the present embodiment, the magnetic metal member is preferably a magnet having a length as long as that of the magnetic roller 201. However, when the combined force indicated by the vector δ is small, for example, it can be disposed partially near the center of the magnetic roller 201. A cross section of the magnet can be in any shape such as circle, elliptic circle, rectangle, square, or other polygonal shapes, and can be symmetric or asymmetric unless the anti-deflection effect thereof is impaired. With regard to the material thereof, it can be ferromagnetic material or soft magnetic material, however, high-permeability materials such as Fe—Ni alloy (permalloy), silicon steel are preferable since they attain a great effect in small volume. In addition, nickel coated magnetic members of SUM series are preferable due to their excellence in anti-rust ability and low price as well as SUS 400 series materials due to their high rigidity and low price.

Note that according to the present embodiment, the magnetic metal member 221 as an anti-deflection magnetic field generator is configured to exert on the magnetic roller 201 (magnetic field generator) a magnetic force sufficient to negate the magnetic force of the magnetic member disposed around the magnetic roller 201 and the gravity of the empty weight of the magnetic roller 201. Here, it should be understood that the negation of the combined force of the magnetic force and the gravity includes “reduction of the combined force”. Therefore, as long as the deflection of the magnetic field generator is reduced and the effect of the present invention is achievable, the reduction of the combined force should be considered as incorporated in the scope of the present invention.

Further, with regard to the empty weight of the magnetic roller 201, in a case where the magnetic roller 201 is very light in weight, a deflection due to the empty weight thereof becomes negligible. However, it should be understood that such a case is also incorporated in the scope of the present invention.

### Second Embodiment

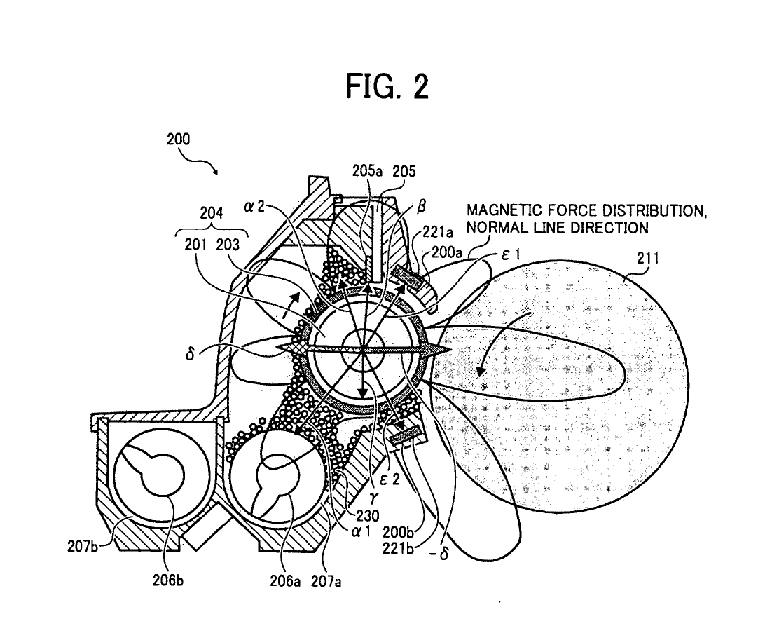

Next, the second embodiment of the present invention will be described with reference to FIG. 2. In the drawing, the same components as those in FIG. 1 are given the same numeric codes. The present embodiment differs from the first embodiment in that two magnetic metal members are disposed on the housing 200a, that the sleeve 203 of the development roller 204 is rotated clockwise and the photoconductive drum 211 is rotated counterclockwise and that the restriction blade for the developer 230 is disposed over the development roller 204 unlike that disposed thereunder in the first embodiment. A large amount of the developer 230 is distributed unevenly on an upstream portion near the agitation screws 206a, 206b and the restriction blade 205. The magnetic metal plate 205a of the restriction blade (doctor blade) 205 is disposed over the sleeve 202 and the magnetic roller 201.

On the center of the magnet roller 201 acts a magnetic force δ as a sum of a magnetic force of a lower left portion of the developer 230 indicated by a vector α1, a magnetic force of an upper left portion thereof indicated by a vector α2, a magnetic force of the magnetic metal plate 205a indicated by a vector β and the empty weight of the magnet roller 201 indicated by a vector γ.

In the development device 200, long magnetic metal members 221a, 221b are disposed as anti-deflection magnetic field generators on housings 200a, 200b over and under the right side of the magnetic roller 201, respectively. The magnetic metal members 221a, 221b exert respective magnetic forces indicated by vectors ε1, ε2 to generate a combined magnetic force thereof indicated by a vector −δ which negates the above-mentioned force indicated by the vector δ. As a result, the deflection of the magnetic roller 201 is prevented which would otherwise occur due to the magnetic force of the developer 230 and the magnetic metal plate 205a and the empty weight of the magnetic roller 201. This accordingly makes it possible to make the amount of the developer 230 attached on the development roller 204 uniform in the longitudinal direction. An image formation apparatus incorporating this development device can form images with even density and high quality.

The present embodiment has described an example where the magnetic metal members are composed of two magnets. However, they can be three or more magnets.

### Third Embodiment

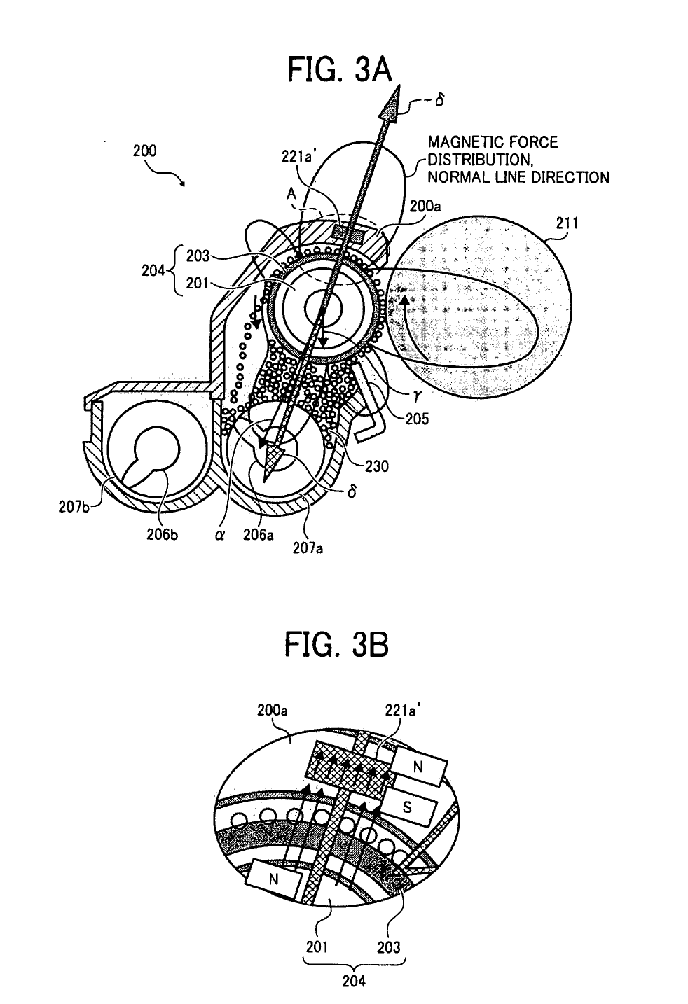

The third embodiment of the present invention will be described with reference to FIGS. 3A, 3B. The same components of the development device as those in the first embodiment are given the same numeric codes.

FIG. 3A shows an example where the developer is attached with a high magnetic flux density (magnetic distribution from the magnetic roller 201 to left-downward in the drawing) in a portion from the agitation screws 206a, 206b to the development roller 204. In this case, a larger amount of the developer 230 is attached thereon, and a higher magnetic attraction acts on the magnetic roller 201 from the developer 230 accordingly, compared with that in the first embodiment. As a result, a larger combined force δ acts on the magnetic roller 201. In order to prevent this from occurring, the magnetic metal member need be increased in volume or the material thereof need be of a high magnetic permeability. However, the former is unfeasible considering the layout of the device, and the latter incurs higher costs.

For the purpose of cancelling the above combined force on the magnetic roller 201 by a magnetic member smaller in volume than the magnetic metal member 221 according to the first embodiment, the present embodiment provides a long plastic magnet 221a′ (FIG. 3B) as an anti-deflection magnetic field generator. The magnet 221a′ is disposed on the housing 200a of the development device 200 such that one side of the magnet 221a′ facing the magnetic roller 201 has polarity (S in the drawing) reverse to that of the magnetic roller 201 (N in the drawing). According to the present embodiment, since the anti-deflection magnetic field generator in small volume can prevent the magnetic roller 201 from having a deflection even with a large amount of force acting thereon, it is possible to make the amount of the developer 230 attached on the development roller 204 uniform in the longitudinal direction. An image formation apparatus incorporating this development device can form images with uniform density and high quality.

Further, the acting force between the magnet 221a′ and the magnetic roller 201 can be adjusted by changing the materials and/or size of the magnet 221a′, and/or changing the amounts of magnetic components thereof.

### Fourth Embodiment

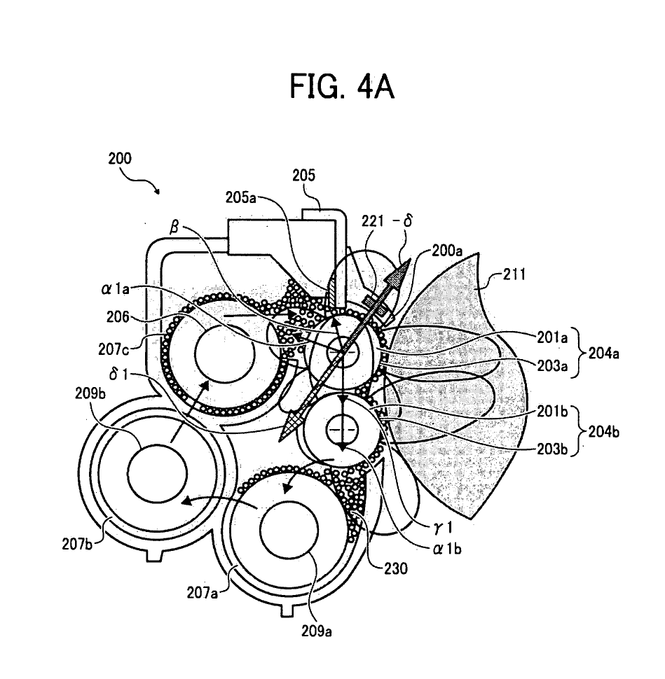

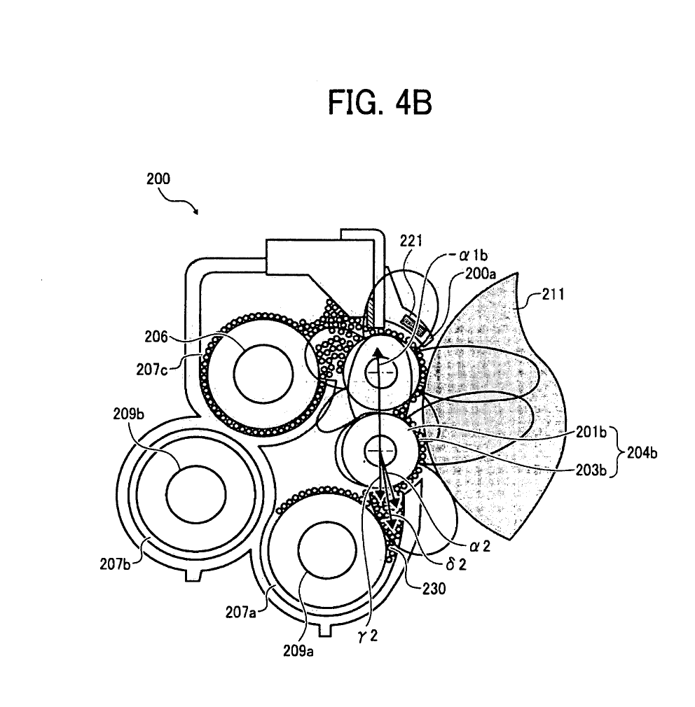

Next, the fourth embodiment of the present invention will be described with reference to FIGS. 4A, 4B. The same components of the development device as those in the first embodiment are given the same numeric codes.

FIGS. 4A, 4B show a development device 200 which includes: a first development roller 204a having a magnetic roller 201a (magnetic field generator) for attracting from an agitation screw 206 a developer 230 in which magnetic particles and toner particles are evenly distributed, to thereby develop a toner onto a photoconductive drum 211, and a metal sleeve 203a containing the magnetic roller 201a; a second development roller 204b which has a magnetic roller 201b and a metal sleeve 203b containing the magnetic roller 201b to peel off the developer 230 from the development roller 204a and develop a toner on the photoconductive drum 211; a recovery screw 209a for recovering the developer 230 separated from the second development roller 204b; and an agitation screw 209b for agitating the developer 230 transferred from the recovery screw 209a and the toner supplied to obtain a toner with a predetermined concentration.

The metal sleeve 203a of the first development roller 204a and the metal sleeve 203b of the second development roller 204b rotate clockwise while the photoconductive drum 211 rotates counterclockwise.

In FIG. 4A, vectors (arrows) show force acting on the center of the magnetic roller 201a of the first development roller 204a.

The development device 200 comprises, as an anti-deflection magnetic field generator, a magnetic member 221 (made of SUM24L nickel coated) on a housing 200a in an upper right side of the development roller 204a. A gravitational force represented by a vector γ1 acts on the magnetic roller 201a of the first development roller 204a, a magnetic force represented by a vector α1a acts between the magnetic roller 201a and the developer 230 unevenly distributed in the upper left side of the first development roller 204a in the drawing, a magnetic force represented by a vector α1b acts between the magnetic roller 201a and the center of the magnetic roller 201b of the second development roller 204b, and a magnetic force represented by a vector β acts on the magnetic roller 201a and the restriction blade 205. The magnetic roller 201a and the magnetic roller 201b magnetically attracts to each other because there is a magnetic force distribution from the magnetic roller 201b to the first development roller 204a in order to transfer the developer 230 from the first development roller 204a to the second development roller 204b. The position and size of the magnetic member 221 are determined so that the sum (represented by a vector δ1) of the above-described forces is to be zero, that is, to obtain a magnetic force −δ1 to negate the combined force δ1.

Moreover, in FIG. 4B, vectors (arrows) show force acting on the center of the magnetic roller 201b of the second development roller 204b and force counteracting it. The magnetic roller 201b receives a magnetic force represented by a vector δ2 which is a sum of a gravitational force of the magnetic roller 201b represented by a vector γ2 and a magnetic force represented by a vector α2 from the developer distributed downward the second development roller 204b. However, the force −α1b (the same degree of force as the force α1b in opposite direction) acting between the magnetic rollers 201a and 201b substantially negates the force δ2, so that a deflection on the magnetic roller 201b is to be negligibly small and does not cause a problem.

According to the development device of the forth embodiment, the two magnetic rollers can be prevented from being deflected, so that the amount of the developer attached on the development roller is made uniform in the longitudinal direction. As a result, it is possible to provide images with even density in the longitudinal direction. Moreover, the development device of the present embodiment includes the two development rollers and has therefore excellent toner developablity, which is advantageous in forming high-quality images since with the two development rollers, the rotation speed thereof can be set relatively slower than that of a single development roller when the rotation speed of the photoconductive drum is not changed. Also, setting the rotation speed thereof the same as that of the single development roller enables further increase in the rotation speed of the photoconductive drum and high-speed development.

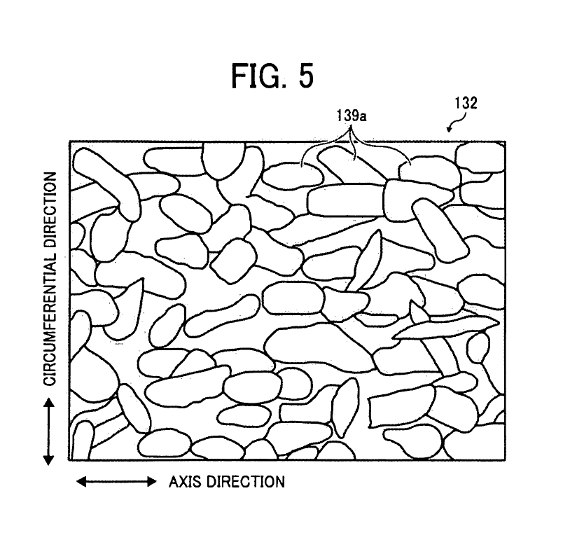

Moreover, according to the development device of the present invention, it is preferable that the non-magnetic hollow body of the developer support body has a large number of elliptic recessions randomly formed on its outer surface. Such recessions can be formed by electromagnetic blast or the like. On the outer surface of the above development sleeve, elliptic recessions in much larger size than those processed by sand blast are formed with long diameter being 0.05 mm or more and 0.3 mm or less and short diameter being 0.02 or more and 0.1 mm or less. FIG. 5 shows an example of such sleeve surface. The developer is retained in recessions 139a randomly on the outer surface of the development sleeve 132. This can prevent unevenness of images. Further, such recessions are unlikely to be worn out over time, have therefore long longevity, and can suppress a decrease in developer attachablity due to secular change.

The developer for use in the development device according to the present invention is preferably made of a toner and a magnetic carrier. The mean particle size of the magnetic carrier is preferably set to be 20 μm or more and 35 μm or less. By use of such a developer, good images excellent in granularity with less unevenness are obtainable. Use of a magnetic carrier of the mean particle size less than 20 μm is not preferable since each carrier particle decreases in magnetization intensity, the magnetic binding force of the magnetic carrier on the development roller weakens and it easily adheres to the photoconductive drum accordingly. Likewise, use of a magnetic carrier of the mean particle size over 35 μm is not preferable either since the magnetic field between the magnetic carrier and the electrostatic latent image on the photoconductive drum will be less dense, making it impossible to form images with evenness and deteriorating quality of images.

### Fifth Embodiment

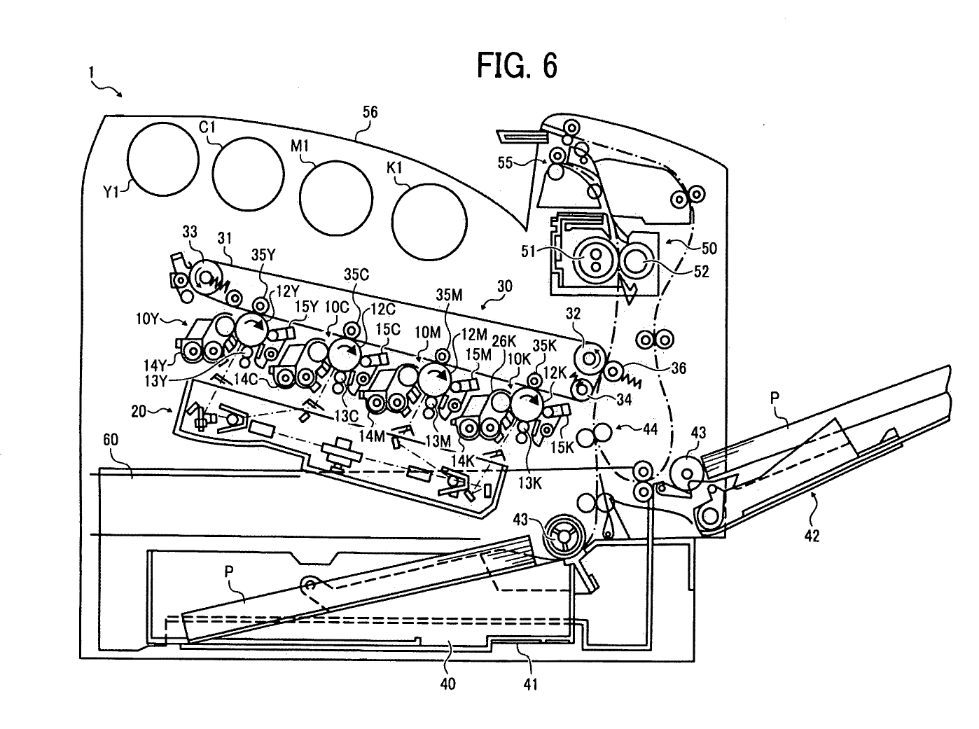

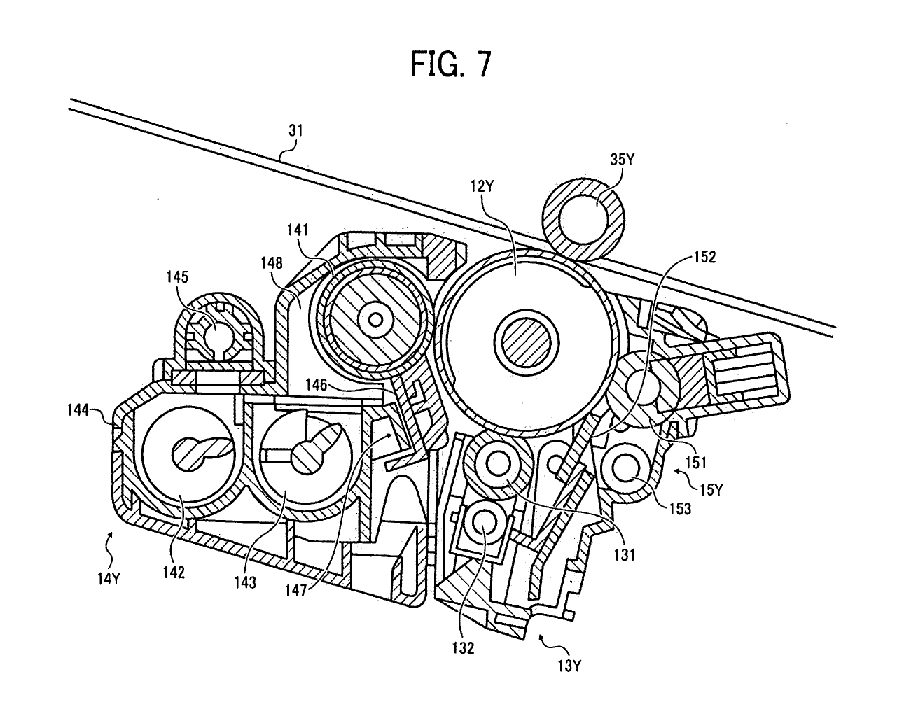

Hereinafter, an image formation apparatus using the development device according to the present invention will be described with reference to FIGS. 6, 7. The present embodiment will be described using as an example an electrophotographic printer capable of forming full-color images.

FIG. 6 shows a printer as an example which includes four-color printing units as process cartridges 10Y (yellow), 10C (Cyan), 10M (magenta), 10K (black), an optical unit 20 as exposure means to emit a laser light, an intermediate transfer body unit 30, a paper feeder 40, a fuser 50, and so on. The printing units 10Y, 10C, 10M, 10K have the same structure, and includes photoconductive drums 12Y, 12C, 12M, 12K, electric chargers 13Y, 13C, 13M, 13K for charging the photoconductive drums, cleaning units 15Y, 15C, 15M, 15K for removing residual magnetic particles or the like on the photoconductive drums, respectively. The printing units 10Y, 10C, 10M, 10K each are configured integrally, and detachably installed in corresponding image formation stations (not shown) provided on an image formation apparatus body 1, and are connected with development devices 14Y, 14C, 14M, 14K to develop latent images formed on the respective photoconductive drums.

The intermediate transfer body unit 30 includes a transfer belt 31, a plurality of (here, three) rollers 32, 33, 34 for rotatably supporting the transfer belt 31, primary transfer rollers 35Y, 35C, 35M, 35K for transferring toner images on the respective photoconductive drums to the transfer belt 31, and a secondary transfer roller 36 for transferring the toner images on the transfer belt 31 to paper P.

The paper feeder 40 includes a paper feed cassette 41, a manual paper feed tray 42, paper feed rollers 43 and register rollers 44 for carrying the paper P to a secondary transfer area from the paper feed cassette 41 or manual paper feed tray 42. The fuser unit 50 has a well-known structure that it includes a fuse roller 51 and a pressure roller 52 to apply heat and pressure on the toner images on the paper P for fusing.

With such a configuration, in the printing unit 10Y, the photoconductive drum 12Y is charged evenly by the electric charger 13Y, and then a latent image thereon is irradiated with the laser light from the optical unit 20 and developed by the development device 14, thereby forming a toner image.

The toner image on the photoconductive drum 12Y is transferred onto the transfer belt 31 by the action of the primary transfer roller 35. Upon completion of the primary transfer, the cleaning device 15Y removes a residual toner on the photoconductive drum 12Y for the next image formation. The removed residual toner is accumulated in a not-shown toner waste bottle which is provided in an eject direction of the printing unit 10Y (rotation axis direction of the photoconductive drum). The toner waste bottle 16 is detachably disposed on the image formation apparatus body 1 to be exchangeable when in full. Similarly, toner images of cyan, magenta, black colors are formed in the printing units 10C, 10M, 10K and transferred and superimposed on a previously formed image in sequence.

Meanwhile, the toner image formed on the transfer belt 31 is transferred by the action of the secondary transfer roller 36 onto the paper P in the secondary transfer area carried from the paper feed cassette 41 or manual paper feed tray 42. The paper P having the toner image thereon is carried to the fuser 50, fused thereby at the fuse roller 51 and a nip portion of the pressure roller 52, and outputted by an output roller 55 to a copy tray 56 in the upper part of the apparatus body 1.

Separated from the printing units, toner vaults Y1, C1, M1, K1 containing toners for replenishment are detachably mounted in the upper part of the apparatus body 1.

Next, FIG. 7 shows an example of a process cartridge according to the present invention. The respective structures of the printing units and development devices are the same except the colors of toners as magnetic particles supplied; therefore, the description will be made using the printing unit 10Y as an example with reference to FIG. 7.

The electric charger 13Y in the printing unit 10Y includes a charge roller 131 and a cleaning roller 132 to clean the surface of the charge roller 131. The cleaning unit 15Y includes a cleaning brush 151 to make a contact with the surface of the photoconductive drum 12Y, a cleaning blade 152, and a toner recovery coil 153 to carry the toner scraped off by the cleaning brush 151 and the cleaning blade 152 toward the toner waste bottle 16.

The development device 14Y is the development device according to the present invention shown in FIG. 1. It includes a development sleeve 141 to support a toner of two-component magnetic particles and rotate counterclockwise in a development area facing to the photoconductive drum 12Y and carry the toner, a doctor blade 146 as a restriction member disposed facing the development sleeve 141 to form a doctor gap S therein restricting a thickness of a toner layer supported on the surface of the development sleeve 141, two agitation screws 142, 143 to agitate magnetic particles contained in the development device 14Y and a replenishing toner supplied from a toner replenishing port 145 and guide the developer to the development sleeve 141 while reciprocating them from/to the photoconductive drum 12Y in the axis direction, and a housing 144 to contain the respective components. The doctor blade 146 is sandwiched and supported by the walls of the housing 144. The magnetic roller is disposed inside the development sleeve 141.

A receiving member 147 is provided close to the doctor blade 146 at a position more upstream in the rotation direction of the development sleeve 141 than the doctor blade 146. The receiving member 147 is supported by the housing 144. The doctor blade 146 and receiving member 147 extend in the axis direction of the photoconductive drum 12Y. The receiving member 147 has a substantially right triangle shape and protrudes from the housing 144 to a space 148 in which the toner is pumped up by the agitation screw 143 and accumulated. Specifically, the receiving member 147 is adjacent to the doctor blade 146 with its top portion of the right triangle protruding towards the surface of the development sleeve 141. Also, the receiving member 147 has a surface 147a to receive toner moving from the space 148 to the doctor blade 146. The top portion of the receiving member 147 is at almost same or slightly lower position than an edge of the doctor blade 146.

According to thus-configured development device 14Y, the receiving member 147 is provided in the space 148 to cover the doctor blade 146 except the doctor gap S so that a pressure of the toner onto the doctor blade 146 decreases, thereby suppressing displacement of the doctor blade 146. Consequently, variance in the amount of the toner supplied onto the photoconductive drum 12Y is extremely small.

Note that the receiving member 147 is provided on the back side of the doctor blade 146 in the present embodiment. However, there is a possibility that a gap occurs between them and the toner flow thereinto, narrowing the space of the doctor gap S. It is preferable to provide a gap S1 therebetween in advance and insert a plate-like elastic member 150 into the gap as a seal member, thereby making it possible to prevent the toner from flowing into the gap and accumulated therein.

According to the present embodiment, the toner bottles are configured to be detachable and replaceable from the apparatus body 1 separately from printing units, which can reduce the number of components replacements and the cost therefor incurred by a user. Further, it is made possible to reduce the number of times at which other components are opened/closed or taken in/taken out, resulting in prevention of toner scattering and improving maintenance performance of the apparatus.

With regard to the toner used in the present embodiment, it is preferably one with sphericity of 0.93 or more. Generally, it is known that it is necessary to use a toner with a small particle size for the purpose of improving image quality. For reducing the toner particle size, conventional pulverized toner has a wide particle size distribution, and is therefore difficult to use. It is more common to increase the circularity of a toner by polymerization or the like and obtain the toner with a narrow particle size distribution to achieve high image quality. However, there is still a problem that the toner with a high circularity is difficult to clean by the cleaning unit since the shape of the particles is close to be spherical. To prevent the problem, the present embodiment provides the receiving member 147 to suppress the variance in the amount of toner supplied onto the photoconductive drum 12Y due to the displacement of the doctor gap S so that the cleaning performance of the cleaning unit can be maintained even by use of the spherical toner particles.

Moreover, the development device according to the present embodiment uses the two-component magnetic carrier which is 20 μm or more and 35 μm or less in the mean particle size. Use of such magnetic carrier enables improvement in the granularity and formation of high-quality images. Also, the above magnetic carrier is composed of a magnetic core member on which a resin film is coated. The resin film is made of resin components in which a thermoplastic resin such as acryl is cross-linked with a melamine resin and charge control agents are contained. Such a magnetic carrier can absorb an impact and suppress occurrence of cracks. Further, due to its large adhesion, it can attain advantageous effects to maintain large particles, prevent an impact on the coated film, and clean spent particles at the same time. Accordingly, the life of the magnetic particles is lengthened by preventing the film cracks and the spent thereof

Further, the development device according to the present embodiment uses for the toner of magnetic particles a polymerized toner obtained by dispersing a toner composition made of at least a prepolymer, a colorant, and a release agent in a water medium under presence of minute resin particles for polyaddition reaction. Use of such a toner is advantageous that it does not need a pulverization process and consumes less resource. Moreover, the toner has narrow particle size distribution and charge distribution, and can be easily changed in degree of circularity.

The image formation apparatus according to the present embodiment comprises magnetic particles made of the above magnetic carrier and the above development sleeve so that it can form images with high quality at high speed.

According to one preferable embodiment of the present invention, the development device is configured to comprise the anti-deflection magnetic field generator which is provided around the hollow body to exert a magnetic force on the magnetic field generator to prevent a deflection of the magnetic field generator by negating at least one of the magnetic force of the magnetic member and a gravitational force due to empty weight of the magnetic field generator. Therefore, a deflection of the magnetic roller can be reduced without increasing the rigidity thereof and the rotation torque of the development sleeve by counteracting the force between the developer and the magnetic field generator which is the strongest magnetic force in the two-component magnetic brush development device. Accordingly, the present invention is able to provide a durable development device to form high-quality images.

According to another preferable embodiment of the present invention, the development device comprises the anti-deflection magnetic field generator in the housing thereof, which eliminates the necessity for provision of a dedicated member therefor.

According to another preferable embodiment of the present invention, in the development device the magnetic member is the developer unevenly distributed around the magnetic field generator and the magnetic member of a restriction blade. Thereby, the deflection of the magnetic roller can be further reduced, resulting in formation of uniform images.

According to another preferable embodiment of the present invention, in the development device the anti-deflection magnetic field generator is made of a magnet so that it can achieve larger ant-deflection effects than that made of a magnetic metal or the like.

According to another preferable embodiment of the present invention, the development device comprises two or more developer support bodies; therefore, it can form images at high speed.

According to another preferable embodiment of the present invention, in the development device the developer is made of a toner and a magnetic carrier, and the mean particle size of the magnetic carrier is 20 μm or more and 35 μm or less, which enables formation of higher quality images.

According to another preferable embodiment of the present invention, in the development device a large number of recessions in an elliptic shape are formed randomly on the outer surface of the non-magnetic hollow body, which enables formation of higher-quality images over a longer period time.

According to another preferable embodiment of the present invention, it is possible to provide a durable process cartridge which can form high-quality images.

According to another preferable embodiment of the present invention, it is possible to provide an image formation apparatus of a long life which can form good uniform images.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. A development device comprising:
a developer support body including a non-magnetic hollow body which contains a magnetic field generator and attracts a developer onto an outer surface by a magnetic force of the magnetic field generator;
a magnetic member being disposed around the magnetic field generator and exerting a magnetic force on the magnetic field generator; and
an anti-deflection magnetic field generator being provided around the hollow body and exerting a magnetic force on the magnetic field generator to prevent a deflection of the magnetic field generator by negating at least one of the magnetic force of the magnetic member and a gravitational force due to empty weight of the magnetic field generator.

2. A development device according to claim 1, wherein
the anti-deflection magnetic field generator is provided in a housing of the development device.

3. A development device according to claim 1, wherein
the magnetic member is a developer unevenly distributed around the magnetic field generator and a magnetic member of a restriction blade.

4. A development device according to claim 1, wherein
the anti-deflection magnetic field generator is made of a magnet.

5. A development device according to claim 1, comprising two or more developer support bodies.

6. A development device according to claim 1, wherein:
the developer is made of a toner and a magnetic carrier; and
a mean particle size of the magnetic carrier is 20 μm or more and 35 μm or less.

7. A development device according to claim 1, wherein
a large number of recessions in an elliptic shape are formed randomly on the outer surface of the non-magnetic hollow body.

8. A process cartridge comprising
a development device comprising a developer support body including a non-magnetic hollow body which contains a magnetic field generator and attracts a developer onto an outer surface by a magnetic force of the magnetic field generator; a magnetic member being disposed around the magnetic field generator and exerting a magnetic force on the magnetic field generator; and an anti-deflection magnetic field generator being provided around the hollow body and exerting a magnetic force on the magnetic field generator to prevent a deflection of the magnetic field generator by negating at least one of the magnetic force of the magnetic member and a gravitational force due to empty weight of the magnetic field generator.

9. An image formation apparatus comprising the process cartridge according to claim 8.
